(19) United States
(12) Patent Application Publication
(10) Pub. No.: US 2012/0134890 A1
(43) Pub. Date: May 31, 2012

(54) OZONE GENERATOR

(75) Inventors: Yohei Kinoshita, Shizuoka-shi (JP); Takashi Sakugawa, Kumamoto-shi (JP); Hidenori Akiyama, Kumamoto-shi (JP)

(73) Assignees: NATIONAL UNIVERSITY CORPORATION KUMAMOTO UNIVERSITY, Kumamoto-shi, Kumamoto (JP); TOYOTA JIDOSHA KABUSHIKI KAISHA, Toyota-shi, Aichi-ken (JP)

(21) Appl. No.: 13/380,752

(22) PCT Filed: Jun. 24, 2010
(86) PCT No.: PCT/IB2010/001605

§ 371 Date: Feb. 7, 2012

(30) Foreign Application Priority Data
Jun. 25, 2009 (JP) 2009-151032

(51) Int. Cl. B01J 19/08

(52) U.S. Cl. 422/186.15; 422/186.07

(57) ABSTRACT

An ozone generator is provided with a pulse generator (110) that at least includes pulse generation means for generating a pulse voltage and a magnetic switch (SI2) adjusting pulse width of the generated pulse voltage, and a discharge reactor that is provided with a plurality of electrodes to which the pulse voltage for which the pulse width has been adjusted is applied, and that generates a discharge between the plurality of electrodes as a result of the pulse voltage, for which the pulse width has been adjusted, being applied thereto, and also generates ozone as a result of a raw material gas containing oxygen being supplied from the outside to between the electrodes where the discharge has been generated.

### INCORPORATION BY REFERENCE

The disclosure of Japanese Patent Application No. 2009-151032 filed on Jun. 25, 2009 including the specification, drawings and abstract is incorporated herein by reference in its entirety.

### BACKGROUND OF THE INVENTION

1. Field of the Invention

The invention relates to the technical field of an ozone (O₃) generator that generates O₃ by electrical discharge.

2. Description of the Related Art

An apparatus provided with a magnetic pulse compression circuit and a discharge tube is disclosed in Japanese Patent Application Publication No. 2004-161509 (JP-A-2004-161509) as an example of this type of apparatus. According to the O₃ generator disclosed in JP-A-2004-161509, a discharge tube is composed of an outer peripheral electrode, a spiral electrode and a rod-like central electrode, and by using the spiral electrode as an electrode for applying a high voltage, the generation efficiency of streamer discharge may be enhanced.

Furthermore, an example of using this type of O₃ generator in an nitrogen oxide (NOx) treatment apparatus is disclosed in Japanese Patent Application Publication No. 2005-222779 (JP-A-2005-222779).

In the O₃ generator disclosed in JP-A-2004-161509, the pulse width of a pulse voltage applied to the electrode is constant. On the other hand, the pulse width most suited for the generation of O₃ varies according to the physical or electrical state of a raw material gas or discharge reactor. Consequently, in an apparatus containing the O₃ generator disclosed in JP-A-2004-161509 in which the pulse width is constant, since, discharge that occurs between the electrodes is streamer discharge suitable for O₃ generation when the pulse width is optimized in advance to the O₃ generation environment, it is difficult to avoid a situation that results in transition to arc discharge, which hardly contributes at all to O₃ generation.

On the other hand, in the O₃ generator disclosed in JP-A-2004-161509, an insulator is arranged between the central electrode and the spiral electrode to protect the discharge reactor from electrically unstable arc discharge. However, when such an insulated structure is constructed, it is practically difficult to effectively prevent a malfunction of the discharge reactor caused by excessive generation of heat or physical damage and the like of the insulator due to arc discharge. In addition, in the case of discharge through this type of insulator, since energy is lost by generation of heat by the insulator and the like, energy efficiency decreases, thereby making it difficult to realize highly efficient O₃ generation. In this manner, in an O₃ generator that is unable to effectively prevent transition to arc discharge, including the O₃ generator disclosed in JP-A-2004-161509, it is difficult to ensure durability as well as realize efficient O₃ generation.

### SUMMARY OF THE INVENTION

The invention provides an O₃ generator that generates O₃ at high efficiency by preventing transition to arc discharge.

An O₃ generator in an aspect of the invention is provided with a pulse generator that at least includes pulse generation means for generating a pulse voltage and a magnetic switch adjusting pulse width of the generated pulse voltage; and a discharge reactor that is provided with a plurality of electrodes to which the pulse voltage for which the pulse width has been adjusted is applied, and that generates a discharge between the plurality of electrodes as a result of the pulse voltage, for which the pulse width has been adjusted, being applied thereto, and also generates O₃ as a result of a raw material gas containing oxygen (O₂) being supplied from the outside to between the electrodes where the discharge has been generated.

In addition, in the O₃ generator in the aspect described above, the magnetic switch may be provided in a signal transmission path between the pulse generation means and the discharge reactor, and may adjust the pulse width of the pulse voltage generated by the pulse generation means.

According to the O₃ generator in the aspect described above, the pulse voltage supplied from the pulse generator is applied between the electrodes of the discharge reactor. Furthermore, “application of a voltage” refers to imparting a potential difference between a high voltage side electrode and a low voltage side electrode. When the pulse voltage is applied between the electrodes, a stream discharge having high oxidative decomposing strength occurs between the electrodes, and O₃, which is a type of active O₂, is generated from O₂ contained in the raw material gas.

Furthermore, the “raw material gas” in the invention refers to a concept that includes O₂-containing gas, and a practical aspect thereof may be O₂ gas of comparatively high purity that is supplied from storage means such as an O₂ canister or O₂ tank through a supply system (such as supply lines, sealings, pressure reducing valves and flow regulator valves), or for example, air or various types of O₂-containing gas introduced from the outside air using an intake apparatus (such as a gas compressor).

Here, in the case of attempting to generate O₃ with high efficiency, the pulse width of the pulse voltage applied between the electrodes (wherein, pulse width refers to a width defined on a time axis) is an important element. For example, although transition from streamer discharge to arc discharge generally occurs easily if the pulse width is large (namely, if the pulse voltage is applied for a long duration), since arc discharge hardly contributes at all to O₃ generation, in the case this transition to arc discharge has occurred, this may lead to a considerable decrease in the O₃ generation amount. On the other hand, if the pulse width is excessively small in order to avoid this transition to arc discharge, the discharge period naturally also becomes short, again making it difficult to ensure an adequate amount of O₃ production.

However, the pulse width optimum for generating O₃ with high efficiency is able to change to a degree that may not be ignored practically corresponding to various conditions, such as the state of the raw material gas (such as the concentration, flow volume or flow rate thereof), weather conditions (such as temperature and pressure), and the configuration (such as the material, composition or structure of the electrodes) or state (such as time-based changes or deterioration) of the discharge reactor.

Thus, when the specifications or circuit configuration of pulse generation means that composes the pulse generator, such as each of the electrical elements or electrical devices that compose a magnetic pulse compression circuit or other peripheral circuits, are optimized for one set of conditions, it is extremely difficult to continuously generate a pulse voltage of a desired pulse width for diversely changing conditions.

Therefore, the O₃ generator in the above aspect employs a configuration in which the pulse generator is provided with a magnetic switch in a signal transmission path between the pulse generation means and the discharge reactor that is able to have various types of modes such as a saturable reactor and is capable of adjusting the pulse width of the pulse voltage generated by the pulse generation means.

According to the O₃ generator in the above aspect, a pulse width that is optimum for O₃ generation capable of changing corresponding to the various conditions described above may be easily obtained as a result of being able to be determined in advance experimentally, empirically, theoretically or on the basis of simulation by changing the switching characteristics of the magnetic switch.

Furthermore, as a preferable practical aspect thereof, the pulse generator in the above aspect refers to a type of power supply apparatus, while a preferred embodiment of the magnetic switch in the above aspect employs a configuration in which it is contained in the power supply apparatus as a portion of that power supply apparatus.

As has been explained above, according to the O₃ generator in the above aspect, a pulse voltage may be applied to the electrodes at an optimum pulse width corresponding to various types of continuously changing conditions due to the action of a pulse generator provided with a magnetic switch. Consequently, stable streamer discharge free of transition to arc discharge may be obtained while ensuring an adequate discharge period. In addition, in consideration of being able to avoid transition to arc discharge, since an insulator is no longer required around the electrodes, the size of the structure thereof may be reduced considerably, and concerns over damage or destruction of the insulator are no longer necessary, cost increases may be preferably inhibited. Moreover, since energy loss attributable to a portion of input energy being converted to joule heat in the insulator may also be avoided, energy efficiency may be preferably improved. Namely, a safe and highly efficient O₃ generator may be realized.

Furthermore, the O₃ generator in the invention exemplified by the above aspect may naturally be applied to a wide range of technical fields requiring O₃, thereby clearly demonstrating the technical significance of the O₃ generator in the invention. For example, the O₃ generator in the invention may be preferably used for various types of water treatment such as domestic wastewater or industrial wastewater (including, for example, water purification, deodorization, odor reduction and disinfection), or exhaust gas purification treatment in automobiles and the like (for example, promotion of oxidative combustion of particulate matter (PM) by promoting the activity of an oxidation catalyst).

In addition, the O₃ generator in the above aspect may also be further provided with supply means for supplying the raw material gas between the electrodes.

According to the above aspect, as a result of employing a configuration in which the O₃ generator is provided with supply means for supplying a raw material gas between electrodes, control of the flow volume, flow rate or O₂ concentration of the raw material gas becomes comparatively easy, thereby enabling extremely stable O₃ generation when coupled with the action of varying pulse width by the magnetic switch.

In addition, the O₃ generator in the above aspect may be further provided with specification means for specifying an O₂ supply amount in the raw material gas, and control means for controlling the number of pulse repetitions in the pulse generator corresponding to the specified supply amount so as to correspond to the magnitude of the O₂ supply amount.

According to the above aspect, the O₂ supply amount in the raw material gas is specified by specification means capable of adopting a form of a single or a plurality of electronic control units (ECU) or other processing units, various types of controllers or various types of microcontroller apparatuses and other computer systems capable of suitably containing one or a plurality of central processing units (CPU), microprocessing units (MPU), various types of processors or various types of controllers, or additionally various types of storage means such as read only memory (ROM), random access memory (RAM), buffer memory or flash memory.

Furthermore, “specification” in the invention refers to the concept that includes ultimately confirming as accessible information in terms of control, such as by detection, computation, estimation, identification, derivation, selection or acquisition, and a process for that purpose is not limited in any way regardless of whether direct or indirect. Furthermore, the “O₂ supply amount in raw material gas” that is specified by the specification means may be the total O₂ supply amount during a fixed or non-fixed period, or the O₂ supply amount per unit time (namely, a supply rate), and moreover, if the O₂ concentration in the raw material gas is constant, stable to a degree that the O₂ concentration may be considered to be constant, or is already identified, it may be substituted with the amount of raw material gas supplied (and the amount of raw material gas supplied may be naturally be used as is if the raw material gas is O₂ gas).

On the other hand, when the O₂ supply amount in the raw material gas is specified, the number of pulse repetitions is controlled corresponding to the specified supplied amount by control means capable of adopting a form of a single or a plurality of ECUs or other processing units, various types of controllers or various types of microcontroller apparatuses and other computer systems capable of suitably containing one or a plurality CPUs, MPUs, various types of processors or various types of controllers, or additionally various types of storage means such as ROM, RAM, buffer memory or flash memory. This “number of pulse repetitions” refers to an indicator for which the magnitude of the number of generations of pulse voltage during a fixed or non-fixed O₃ generation period or the number of generations of pulse voltage per unit time are respectively correlated with the magnitude of the O₃ generation amount.

Here, the control means controls the pulse generator so that the magnitude of the O₂ supply amount (which is equal to the magnitude of the amount of raw material gas supplied if the O₂ concentration is roughly constant) respectively corresponds in a one-to-one, one-to-many, many-to-one or many-to-many relationship to the magnitude of the number of pulse repetitions. Thus, according to this aspect, in the case the O₂ supply amount is comparatively large, the period during which O₂ is supplied for O₃ generation becomes long, on the other hand, in the case the O₂ supply amount is comparatively small, the period during which O₂ is supplied for O₃ generation becomes short, as a result, highly efficient O₃ generation is promoted corresponding to the O₂ supply amount.

Furthermore, in consideration of the magnitude of the O₂ supply amount ultimately being able to respectively correspond to the magnitude of the O₃ generation amount, the control means, or other means differing from the control means, may control the O₂ supply amount (or the amount of raw material gas supplied in a practically preferable embodiment) corresponding to a required amount of O₃ at that time or operating conditions or environmental conditions and the like of a vehicle.

In addition, in the O₃ generator in the above aspect, the magnetic switch may be electrically arranged in parallel with the discharge reactor, and the pulse generator may be configured so that the pulse width is adjusted according to time required to switch a switching state in the magnetic switch.

According to the above aspect, the pulse generator may be constructed comparatively simply, and is also practically advantageous since control of pulse width is comparatively easy.

Furthermore, in a preferable embodiment, the “time required to switch the switching state” refers to the amount of time required for the magnetic switch to switch from a reset state to an on state (namely, a magnetically saturated state), and in the case of configuring the magnetic switch as a saturable reactor, for example, the saturable reactor may be preferably controlled by varying direct current applied to a direct current coil or reset coil provided separately from an alternating current coil.

In addition, in the O₃ generator in the above aspect, the pulse generator may further have a reset circuit adjusting the time required to switch the switching state according to a prescribed reset current.

According to the above aspect, in the case of employing a constitution in which a reset circuit is provided as a circuit capable of resetting the magnetic switch by magnetizing until saturated in a direction of magnetization thereof, for example, since the amount of time required to switch the switching state may be adjusted corresponding to the reset current, the pulse width of pulse voltage supplied from the pulse generator may be preferably adjusted.

In addition, in the O₃ generator in the above aspect, the pulse width may also be adjusted so as to be equal to or greater than the discharge period and so that a difference with the discharge period is equal to or less than a prescribed value.

According to the above aspect, since the pulse width has a length on a time axis that is equal to or greater than the discharge period, together with ensuring maximum generation of O₃, since application of pulse voltage is terminated until an amount of time corresponding to a prescribed value elapses following completion of discharge, transition to arc discharge attributable to increasing pulse width may be effectively prevented. In addition, in consideration of avoiding the wasteful application of pulse voltage not contributing to actual O₃ generation in this manner, the application cycle of the pulse voltage may be shortened, thus making this remarkably effective in allowing efficient O₃ generation.

Furthermore, in a preferable embodiment, the prescribed value in this aspect refers to an adequately small value determined in advance experimentally, empirically or on the basis of simulation so that application of the pulse voltage terminates immediately after completion of discharge.

In addition, in the O₃ generator in the above aspect, the pulse generation means may also include a reference pulse generation circuit that generates a reference pulse voltage serving as a reference for the pulse voltage, and a magnetic pulse compression circuit that carries out magnetic pulse compression on the reference pulse voltage.

According to the above aspect, since the pulse generation means employs a configuration that includes a reference pulse generation circuit, which generates a reference pulse voltage by using a reference voltage supplied from various types of power supplies such as a residential power supply, industrial power supply (such as a 100 V or 200 V power supply) or various types of vehicle-mounted batteries and other power supplies, and a magnetic pulse compression circuit, which is able to compress and suitably boost the pulse width of the reference pulse voltage generated by the reference pulse generation circuit by a magnetic action, pulse voltages compatible with a diverse range of applications may be generated comparatively easily.

In addition, in the O₃ generator in the above aspect, the O₃ generator may be installed on a vehicle, and the O₃ generator may be made to generate an amount of O₃ required to purify exhaust of the vehicle based on an operating status of the vehicle.

According to the above aspect, an optimum amount of O₃ may be generated (produced) corresponding to the generated amount of O₃ required by the vehicle whenever O₃ is required.

### BRIEF DESCRIPTION OF THE DRAWINGS

The foregoing and/or further objects, features and advantages of the invention will become more apparent from the following description of example embodiments with reference to the accompanying drawings, in which like numerals are used to represent like elements, and wherein:

FIG. 1 is a block diagram of an O₃ generator in a first embodiment of the invention;

FIG. 2 is a drawing for explaining the circuit configuration of a pulsed power supply in the O₃ generator of FIG. 1;

FIG. 3 is a schematic perspective view schematically representing the configuration of a discharge reactor in the O₃ generator of FIG. 1;

FIG. 4 is a time characteristics diagram (comparative example) of a load voltage and a load current in a configuration in which a pulsed power supply does not have a magnetic switch for adjusting pulse width as related to effects of the invention;

FIG. 5 is a time characteristics diagram of a load voltage and a load current corresponding to an adjustment state of a magnetic switch for adjusting pulse width as related to effects of the invention;

FIG. 6 is a time characteristics diagram of a load voltage and a load current corresponding to another adjustment state of a magnetic switch for adjusting pulse width as related to an effect of the invention; and

FIG. 7 is a block drawing of an O₃ generator in a second embodiment of the invention.

### DETAILED DESCRIPTION OF EMBODIMENTS

Actions and other such advantages of the invention will be made clear from the embodiments explained below.

The following provides an explanation of embodiments of the O₃ generator of the invention with suitable reference to the drawings. First, an explanation is provided of the configuration of an O₃ generator 100 in a first embodiment of the invention with reference to FIG. 1. Here, FIG. 1 is a block drawing of the O₃ generator 100.

In FIG. 1, the O₃ generator 100 is an example of the “O₃ generator” in the invention that is provided with a pulsed power supply 110 and a discharge reactor 120. Although the O₃ generator 100 may be installed or equipped in a wide range of applications, such as various types of water treatment plants for carrying out reforming treatment, disinfecting treatment, purification treatment or deodorizing treatment of domestic wastewater or industrial wastewater and the like, vehicles equipped with an oxidation catalyst for exhaust purification in an exhaust path thereof, or various types of treatment equipment provided with a treatment process requiring O₃, since the correlation between the application target of the O₃ generator 100 and the invention is low, the details thereof are omitted in this embodiment. In addition, since chemical processes for generating O₃ that use discharge phenomena are commonly available, no mention is made of these processes herein.

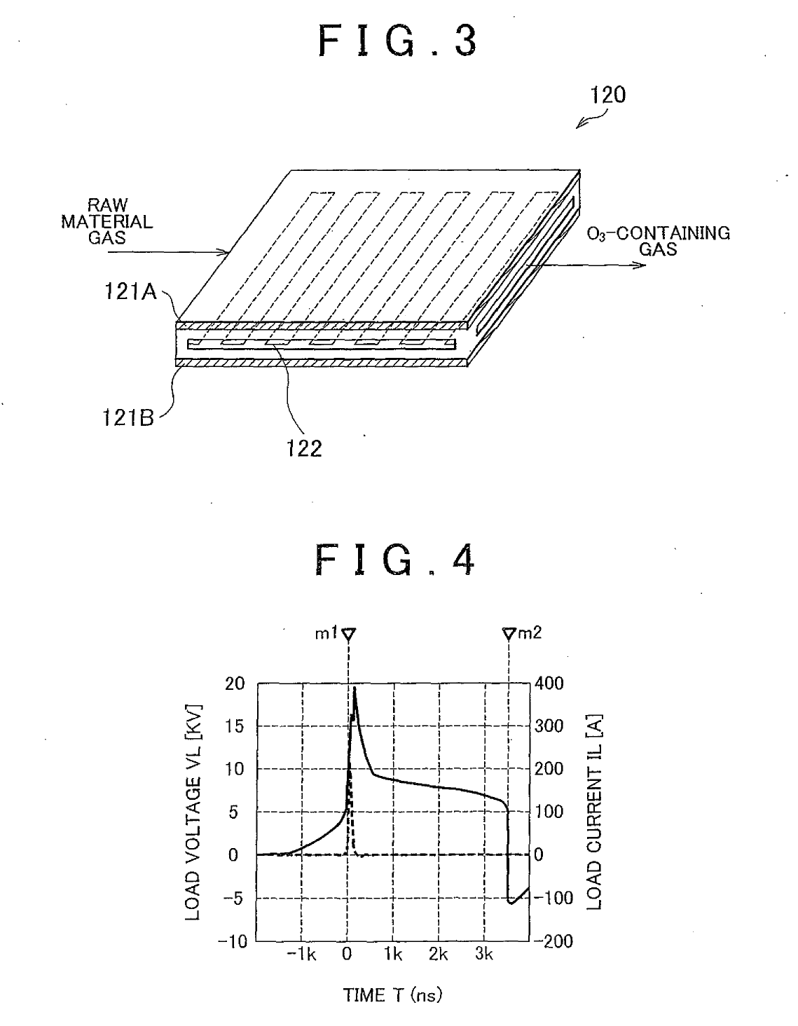

The pulsed power supply 110 is an example of the “pulse generator” in the invention, and is configured to be able to apply a pulse voltage Vp between high-voltage electrodes 122 and low-voltage electrodes 121A and 121B to be subsequently described of the discharge reactor 120 (see FIG. 3).

The discharge reactor 120 is an example of the “discharge reactor” in the invention, and is configured so as to generate a discharge in a prescribed discharge space by the pulse voltage Vp applied through the pulsed power supply 110. The discharge reactor 120 employs a configuration in which a raw material gas containing O₂ is supplied to the discharge space of the discharge reactor 120 from a raw material gas supply apparatus not shown, and O₃ is generated from the raw material gas in the discharge space due to the action of discharge. Raw material gas that has passed through the discharge space is exhausted from the discharge reactor 120 as O₃-containing gas containing the generated O₃.

Furthermore, the raw material gas may be air, O₂ gas or other gas that contains O₂.

Next, an explanation is provided of the operation of the O₃ generator 100 in this embodiment along with the detailed configuration of the O₃ generator 100.

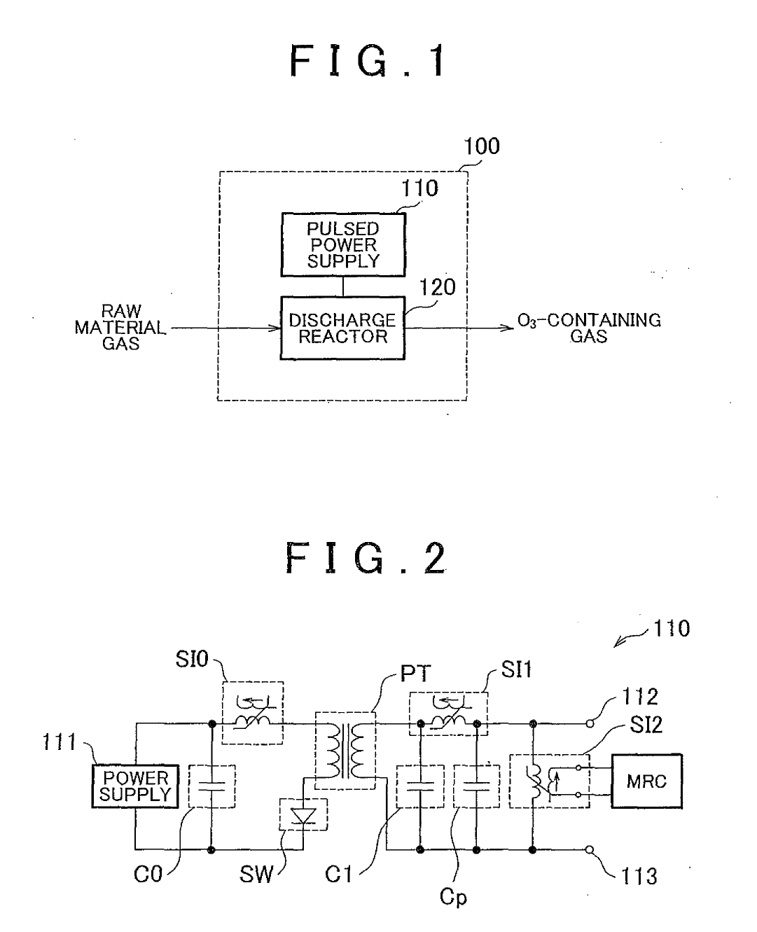

First, an explanation is provided of the configuration and operation of the pulsed power supply 110 with reference to FIG. 2. Here, FIG. 2 is a drawing for explaining the circuit configuration of the pulsed power supply 110. Furthermore, in the drawing, those portions of FIG. 2 that coincide with FIG. 1 are indicated with the same reference numerals and an explanation thereof is suitably omitted.

In FIG. 2, the pulsed power supply 110 is provided with a power supply 111, a first-stage capacitor C0, a semiconductor switch SW and a saturable reactor SI0. Furthermore, these constitute one example of a “reference pulse generation circuit” in the invention.

The power supply 111 is a power supply apparatus that suitably connects ancillary circuits such as a booster circuit to a residential power supply, industrial power supply (such as a 100 V or 200 V power supply), portable battery or vehicle-mounted battery. The first-stage capacitor C0 is a capacitor inserted in parallel with the power supply 111 that is initially charged by the power supply 111. The semiconductor switch SW is a switching element composed of an element such as a thyristor, gate turn-off thyristor (GTO), insulated gate bipolar Transistor (IGBT), field effect transistor (FET) or gain control transistor (GCT), and the switching state thereof is suitably switched by a control circuit not shown.

In the pulsed power supply 110, when the semiconductor switch SW is controlled to ON with the first-stage capacitor C0 initially charged to an initial charge voltage VC0, pulse current is supplied from the first-stage capacitor C0 to a pulse transformer PT to be subsequently described via the saturable reactor SI0. The saturable reactor SI0 is configured to function as a magnetic assist that reduces switching loss of the semiconductor switch SW by becoming saturated after the magnetic switch SW has completely switched to the ON state.

In FIG. 2, the pulsed power supply 110 is further provided with the pulse transformer PT, a capacitor C1, a peaking capacitor Cp and a saturable reactor SI1. Furthermore, these constitute one example of a “magnetic pulse compression circuit” in the invention.

The pulse transformer PT is configured to generate a boost pulse current resulting from the boosted pulse voltage in a secondary side output stage when the previously described pulse current is supplied to a primary side input stage. The capacitor C1 is then charged to a charge voltage VC1 by this boost pulse current.

On the other hand, the saturable reactor SI1 demonstrates the action of a magnetic switch due to the charge voltage VC1 of the capacitor C1, and converts the previous boost pulse current to a compressed pulse current that has undergone magnetic pulse compression (namely, pulse width reduction). This compressed pulse current that has undergone magnetic pulse compression is used to charge the peaking capacitor Cp. Furthermore, in this embodiment, the relationship between electrostatic capacitance CC1 of the capacitor C1 and electrostatic capacitance CCp of the peaking capacitor Cp satisfies the relationship CC1>CCp (for example, CC1=1.0 nF and CCp=0.2 nF), and a high voltage may be obtained for the peaking capacitor Cp.

Furthermore, the circuit configuration of the pulsed power supply 110 in this embodiment is merely one example of a practical aspect able to be adopted by the “pulse generation means” in the invention, and the “pulse generation means” in the invention is not limited to that of the pulsed power supply 110, but rather may adopt various aspects. For example, the pulsed power supply 110 may be provided with a plurality of magnetic pulse compression stages composed of saturable reactors and capacitors, or may be provided with a saturable transformer instead of the pulse transformer PT. Alternatively, the pulse transformer PT may be replaced with two stages consisting of the pulse transformer PT and a saturable transformer.

The pulsed power supply 110 is provided with a saturable reactor SI2 in parallel with the peaking capacitor Cp.

The saturable reactor SI2 is a magnetic switch having a configuration in which a mutually magnetically coupled main coil and reset coil are wound on a core composed of a magnetic body in the same manner as the saturable reactor SI0 and saturable reactor SI1, and is one example of the “magnetic switch” in the invention that is configured to be able to adjust pulse width of the pulse voltage applied between a load terminal 112 and a load terminal 113 (namely, an example of the “pulse voltage” in the invention) by adjusting switching characteristics relating to the magnetic switching action thereof.

More specifically, in the saturable reactor SI2, magnetic saturation characteristics of the core may be changed and switching characteristics may be changed by varying the number of windings of the main coil or reset coil or the current relative to the reset coil. When the saturable reactor SI2 is switched to the ON state (namely, when the core has become magnetically saturated and enters a state of low impedance), the pulse voltage applied between the load terminal 112 and the load terminal 113 falls suddenly, thereby enabling the pulse width of the pulse voltage to be adjusted.

Here, a magnetic reset circuit (MRC) is electrically connected to the reset coil of the saturable reactor SI2. The MRC is provided with a direct current power supply, a protective circuit and the like not shown, and is configured to be able to supply a direct current reset current to the reset coil of the saturable reactor SI2. This MRC is configured so that the driving state thereof is controlled by a control circuit not shown, and after the saturable reactor SI2 has switched to an ON state, magnetically resets the core of the saturable reactor SI2 by supplying a direct current reset current in the form of an inverse exciting current to the reset coil (namely, eliminates any residual magnetization or saturates the core in the direction of reverse excitation). Furthermore, the protective circuit is a circuit having various available aspects that protects a direct current power supply so that a high induced voltage is not applied to the direct current power supply when the saturable reactor SI2 demonstrates the action of a magnetic switch.

Here, the MRC is particularly configured to be able to variably control the magnitude of the reset current supplied to the reset coil. Since the reset state of the saturable reactor SI2 changes when the reset current value changes, the switching characteristics of the saturable reactor SI2, or in other words the amount of time until it is switched to the ON state (namely, the “amount of time required to switch the switching state in the magnetic switch” in the invention), change. In this manner, the MRC is able to adjust the pulse width of the pulse voltage Vp supplied to the discharge reactor 120 by changing the magnetic switching characteristics of the saturable reactor SI2. Namely, the MRC is an example of the “reset circuit” in the invention.

Furthermore, although omitted from the drawings, a similar to the MRC is also provided in the saturable reactor SI1 that composes a magnetic pulse compression circuit and in the saturable reactor SI0 that composes a reference pulse generation circuit. However, these MRCs are literally for obtaining a reset state for allowing repeated application of the pulse voltage Vp, and do not have an action for adjusting the pulse width of the pulse voltage Vp as possessed by the saturable reactor SI2.

Furthermore, the control circuit of the previously described semiconductor switch SW and the control circuit of this MRC may each be separate or they may be integrally composed. In addition, these control circuits may constitute a portion of a control apparatus capable of controlling all operations of the O₃ generator 100.

Next, an explanation is provided of the configuration and operation of the discharge reactor 120 with reference to FIG. 3. Here, FIG. 3 is a schematic perspective view conceptually representing the configuration of the discharge reactor 120. Furthermore, in this drawing, those portions of FIG. 3 that coincide with FIG. 1 are indicated with the same reference numerals and an explanation thereof is suitably omitted.

In FIG. 3, the discharge reactor 120 uses an acrylic material as an outer enclosure, and is provided with low-voltage electrodes 121A and 121B in the form of mutually opposing plates. The low-voltage electrodes 121A and 121B are potentially grounded metal electrodes for applying a low voltage, and are configured so as to be connected to the load terminal 113 of the pulsed power supply 110. A void is formed between the low-voltage electrode 121A and the low-voltage electrode 121B that forms the previously described discharge space. In addition, the discharge reactor 120 is configured such that raw material gas is supplied to the discharge space from the direction indicated by the arrow in the drawing, and O₃-containing gas is similarly exhausted from the discharge space as shown by the arrow in the drawing.

On the other hand, the discharge reactor 120 is provided with wire-like high-voltage electrodes 122. The high-voltage electrodes 122 are metal electrodes arranged so as to intersect the flow path of the raw material gas within the discharge space, and is configured to be able to generate an electrically stable streamer discharge between the low-voltage electrodes 121A and 121B when a pulse voltage, for which pulse width has been adjusted by the saturable reactor SI2, has been supplied from the pulsed power supply 110 through the load terminal 112.

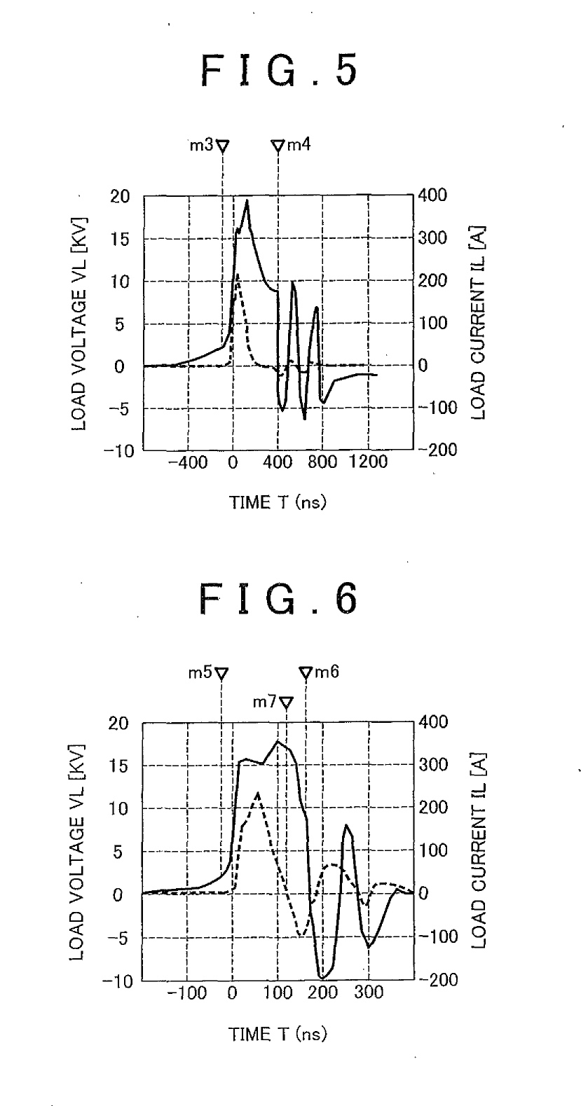

Next, an explanation is provided of effects of the O₃ generator 100 in this embodiment with reference to FIGS. 4 to 6. Here, FIG. 4 is a time characteristics diagram equivalent to a comparative example of this embodiment that indicates an example of time characteristics of a load voltage VL and a load current IL in the case of using the pulsed power supply 110 not having the saturable reactor SI2, FIG. 5 is a time characteristics diagram that indicates an example of time characteristics of the load voltage VL and the load current IL corresponding to an adjustment state of the saturable reactor SI2, and FIG. 6 is a time characteristics diagram that indicates an example of time characteristics of the load voltage VL and the load current VI corresponding to another adjustment state of the saturable reactor SI2. Furthermore, in these drawing, those portions that mutually coincide with other portions are indicated with the same reference numerals and an explanation thereof is suitably omitted. Furthermore, the load voltage VL refers to a voltage between load terminals in the case the pulsed power supply 110 is used as a load and the discharge reactor 120 is connected between the load terminal 112 and the load terminal 113, while the load current IL similarly refers to a current generated between the load terminals.

In FIG. 4, the load voltage VL (kV) and the load current IL (A) are plotted on the vertical axes, while time T (ns) is plotted on the horizontal axis. Furthermore, in FIG. 4, the solid line in the diagram corresponds to the load voltage VL while the broken line corresponds to the load current IL. Furthermore, FIG. 4 is a schematic characteristics diagram for clarifying the action of the saturable reactor SI2 in the O₃ generator 100.

In FIG. 4, in a configuration not having the saturable reactor SI2 indicated as an example of the magnetic switch in the invention, since the pulse width of the pulse voltage supplied to the discharge reactor 120 cannot be adjusted, the pulse width may only be a single pulse width made to be compatible in advance. Consequently, the pulse width of the pulse voltage easily diverges from an optimum value depending on O₂ concentration in the raw material gas, the flow volume or flow rate of the raw material gas, or the deterioration state or configuration of the discharge reactor 120 and the like. FIG. 4 provides a representation of this state, and in FIG. 4, the pulse width of the load voltage VL, which is affected by the pulse width of the pulse voltage, is about 3000 ns (namely, 3 μs), and the pulse voltage continues to be supplied over a long period of time (see markers m1 and m2 in the drawing).

When pulse width increases in this manner, discharge in the discharge reactor 120 easily undergoes transition from streamer discharge, which contributes to O₃ generation, to arc discharge, which does not contribute to O₃ generation, or arc discharge occurs easily, and the O₃ generation amount easily decreases considerably. In addition, the deployment of electrically insulating countermeasures for the discharge reactor 120 becomes unavoidable due to the difficulty in avoiding transition to arc discharge, thereby resulting in the need for an insulator that covers the high-voltage electrodes 122. Since energy loss occurs in the insulator in the case of discharge through such an insulator, highly efficient O₃ generation becomes even more impossible.

On the other hand, FIG. 5 indicates time characteristics of the load voltage VL and the load current IL in the case of using a value N1 for the number of windings N of the main coil of the saturable reactor SI2 in the pulsed power supply 110 provided with the saturable reactor SI2 (as related to this embodiment).

In FIG. 5, the pulse width of the pulse voltage applied to the discharge reactor 120 is about 400 ns, and has been compressed dramatically as compared with the comparative example (FIG. 4). This is the result of providing the saturable reactor SI2 as a magnetic switch for adjusting pulse width, and by adjusting each type of parameter for adjusting pulse width (although the number of windings N of the main coil is used here, this may also be the number of windings of the reset coil or the previously described reset current), and yields the effect of being able to adjust the pulse width of the pulse voltage applied to the discharge reactor 120 over a wide range.

In the case of providing the saturable reactor SI2 in this manner, the pulse width of the pulse voltage may be easily optimized corresponding to the raw material gas and the state of the discharge reactor 120. At this time, since optimization of pulse width naturally refers to optimization of O₃ generation efficiency, highly efficient O₃ generation becomes possible. In addition, since transition to arc voltage may be prevented, it is no longer necessary to cover the high-voltage electrodes 122 of the discharge reactor 120 with an insulator, thereby enabling highly efficient O₃ generation with respect to this point as well. Moreover, as a result of stabilizing discharge, the initial charge voltage VC0 of the first-stage capacitor C0 per se may also be increased, thereby enabling O₃ generation at even higher efficiency.

On the other hand, FIG. 6 indicates time characteristics of the load voltage VL and the load current IL in the case of using a value N2 (N2<N1) for the number of windings N of the main coil of the saturable reactor SI2 in the pulsed power supply 110 provided with the saturable reactor SI2.

According to FIG. 6, the pulse width of the pulse voltage is about 200 ns, indicating that the pulse width has been compressed considerably with respect to the comparative example (FIG. 4) (see markers m5 and m6) in the same manner as FIG. 5, thereby making it possible to obtain the same effects as described above.

In FIG. 6 in particular, the timing at which the pulse voltage falls is reached immediately after completion of discharge (see marker m7 in the drawing) (or in other words, the saturable reactor SI2 reaches the time at which it switches), thereby nearly completely eliminating the application of wasted pulse voltage without inhibiting discharge required for O₃ generation (namely, an example of “adjusting the pulse width so as to be equal to or greater than a discharge period and so that the difference with the discharge period is equal to or less than a prescribed value” in the invention). In the case of the pulse width being adjusted so that the saturable reactor SI2 switches to the ON state immediately after completion of discharge in this manner, in addition to providing further stabilization of discharge, the cycle at which application of the pulse voltage is repeated may be shortened, thereby enabling O₃ generation at even higher efficiency.

As has been explained above, according to the O₃ generator 100 in this embodiment, as a result of the pulsed power supply 110 being provided with the saturable reactor SI2 as an example of the magnetic switch in the invention, switching characteristics of the saturable reactor SI2 may be adjusted in advance based on an experimental, empirical or theoretical viewpoint or based on various types of simulations, or may be adjusted on a real-time basis corresponding to the state of raw material gas or the state of the discharge reactor at that time after having actually installed the O₃ generator 100 (such as after mounting in a vehicle), thereby enabling O₃ to be generated as efficiently as possible without causing a transition to arc discharge.

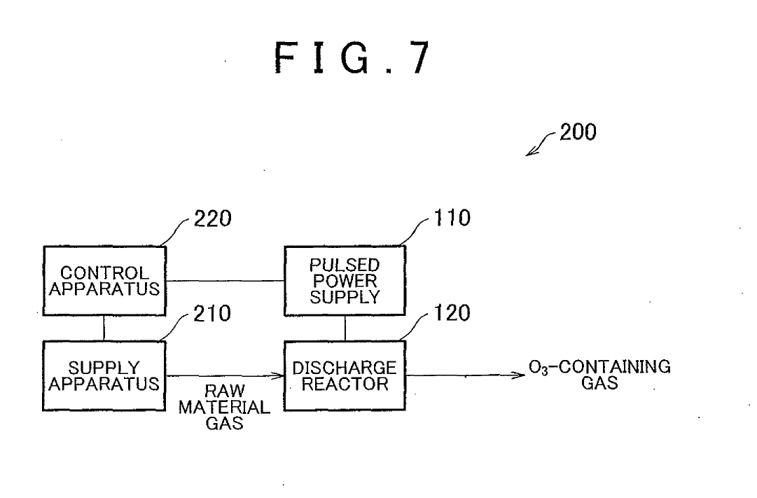

Next, an explanation is provided of an O₃ generator 200 in a second embodiment of the invention with reference to FIG. 7. Here, FIG. 7 is a block diagram of the O₃ generator 200. Furthermore, in the drawing, those portions of FIG. 7 that coincide with FIG. 1 are indicated with the same reference numerals and an explanation thereof is suitably omitted.

In FIG. 7, the O₃ generator 200 employs a configuration in which a supply apparatus 210 and a control apparatus 220 are further added to the O₃ generator 100 in the first embodiment.

The supply apparatus 210 is connected to the discharge reactor 120, and is an example of the “supply means” in the invention that is configured to be able to supply the raw material gas to the discharge reactor 120. Furthermore, although the supply apparatus 210 is able to adopt various aspects corresponding to the application of the O₃ generator 200, the O₃ generator 200 is explained here as purifying exhaust by being installed in a vehicle. Namely, in this case, the raw material gas is outside air (air).

The supply apparatus 210 is provided with an outside air intake tube formed in the body of vehicle, a gas compressor installed in this outside air intake tube, and a mass flow meter installed in this outside air intake tube downstream from the gas compressor (all of which are not shown in the drawing).

The gas compressor is an electrically driven fluid compression apparatus provided by a turbine that is driven by a voltage supplied from a vehicle-mounted battery, and is configured so as to be able to supply outside air aspirated from the upstream side under pressure to the downstream side at a discharge pressure that varies corresponding to the rotating speed of the turbine. In addition, this gas compressor is electrically connected to the control apparatus 220 and is configured so that the rotating speed of the turbine is controlled by the control apparatus 220.

On the other hand, the mass flow meter is configured to be able to detect the flow rate of outside air supplied under pressure downstream from the gas compressor. In addition, the mass flow meter is also electrically connected to the control apparatus 220, and the amount of outside air supplied to the discharge reactor 120 is constantly monitored by the control apparatus 220. The control apparatus 220 feeds back the supplied amount of outside air acquired from the gas flow meter to control of turbine rotating speed, and is configured to supply a suitable amount of outside air corresponding the required amount of O₃ to be generated, which is determined separately corresponding to operating conditions of the vehicle, to the discharge reactor 120. Furthermore, outside air refers to air, and under ordinary environmental conditions, the O₂ content thereof is generally constant. Thus, the supplied amount of outside air as detected by the mass flow meter is equal to the amount of O₂ supplied to the discharge reactor 120. Namely, the mass flow meter together with the control apparatus 220 constitute an example of the “specification means” in the invention.

The control apparatus 220 is an electronic control apparatus that is configured as a portion of a vehicle ECU that performs comprehensive control of vehicle operating status, and is an example of the “control means” in the invention that is configured to be able to control operating status of the O₃ generator 200.

When vehicle operating conditions are estimated on the basis of various types of sensors installed in the vehicle, the control apparatus 220 calculates a required amount of O₃ based on the estimated operating conditions. When a supplied amount of O₃ is obtained that matches the calculated required amount of O₃, the detection results of the mass flow meter are fed back to control the driving status of the supply apparatus 210. As a result, a suitable amount of O₂ is supplied to the discharge reactor 120 at all times.

Moreover, the control apparatus 220 controls the number of pulse repetitions in the pulsed power supply 110 by controlling the switching state of the semiconductor switch SW in the pulsed generator 110. More specifically, the switching state of the semiconductor switch SW is controlled so that the magnitude of the O₂ supply amount (namely, the amount of outside air supplied) to the discharge reactor 120 corresponds to the magnitude of each number of pulse repetitions. Since magnitude of the number of pulse repetitions corresponds to the magnitude of the O₃ generation amount, the required amount of O₃ to be generated may be accurately obtained by controlling the number of pulse repetitions.

In this manner, according to the O₃ generator 200 in this embodiment, as a result of the supply apparatus 210 and the control apparatus 220 constituting a portion of the O₃ generator 200, the optimum amount of O₃ may be preferably generated (produced) corresponding to the amount of O₃ required to be generated by the vehicle each time O₃ is required, thereby promoting highly efficient O₃ generation backed by satisfactory controllability.

Furthermore, the control apparatus 220 may also be configured to further enable control of the driving status of the previously described MRC. In this case, since the control apparatus 220 enables real-time adjustment of the pulse width of the pulse voltage Vp through control of the reset current value of the MRC, the pulse width of the pulse voltage Vp may be aligned with the optimum pulse width that may change corresponding to the operating conditions or environmental conditions of the vehicle, thereby making the practical advantage thereof extremely significant.

Furthermore, although the O₃ generator 200 was used to purify vehicle exhaust in this embodiment, there is naturally only one example of the application thereof, and the O₃ generator 200 may be applied to the various applications previously described. At this time, the configuration of the supply apparatus 210 may be changed corresponding to the application to which it is applied. For example, in the case the O₃ generator 200 employs a configuration in which it is installed in various types of facilities instead of a moving body, the supply apparatus may have a configuration that includes storage means such as an O₂ canister or O₂ tank for storing O₂ gas at a comparatively high concentration, or a configuration capable of supplying O₂ gas from the storage means to the discharge reactor 120. More specifically, the supply apparatus may employ a configuration that is provided with gas lines, pressure reducing valves, pressure regulator valves, flow regulator valves and various types of coupling members that suitably couple these components while maintaining air tightness.

The invention can be applied to, for example, an apparatus that uses O₃ to carry out reforming, disinfection, purification or deodorization treatment and the like on liquids or gases.

The invention, has been described with reference to example embodiments for illustrative purposes only. It should be understood that the description is not intended to be exhaustive or to limit form of the invention and that the invention may be adapted for use in other systems and applications. The scope of the invention embraces various modifications and equivalent arrangements that may be conceived by one skilled in the art.

1. An ozone generator, comprising:
a pulse generator that at least includes pulse generation portion that generates a pulse voltage and a magnetic switch adjusting pulse width of the generated pulse voltage; and
a discharge reactor that is provided with a plurality of electrodes to which the pulse voltage for which the pulse width has been adjusted is applied, and that generates a discharge between the plurality of electrodes as a result of the pulse voltage, for which the pulse width has been adjusted, being applied thereto, and also generates ozone as a result of a raw material gas containing oxygen being supplied from the outside to between the electrodes where the discharge has been generated.

2. The ozone generator according to claim 1, wherein the magnetic switch is provided in a signal transmission path between the pulse generation portion and the discharge reactor, and adjusts the pulse width of the pulse voltage generated by the pulse generation portion.

3. The ozone generator according to claim 1, further comprising supply portion that supplies the raw material gas between the electrodes.

4. The ozone generator according to claim 1, further comprising:
specification portion that specifies an oxygen supply amount in the raw material gas, and
control portion that controls the magnitude of the number of pulse repetitions in the pulse generator corresponding to the specified supply amount so as to correspond to the magnitude of the oxygen supply amount.

5. The ozone generator according to claim 1, wherein:
the magnetic switch is electrically arranged in parallel with the discharge reactor, and
the pulse generator is configured so that the pulse width is adjusted according to time required to switch a switching state in the magnetic switch.

6. The ozone generator according to claim 5, wherein the pulse generator further includes a reset circuit adjusting the time required to switch the switching state according to a prescribed reset current.

7. The ozone generator according to claim 1, wherein the pulse width is adjusted so as to be equal to or greater than the discharge period and so that a difference with the discharge period is equal to or less than a prescribed value.

8. The ozone generator according to claim 1, wherein the pulse generation portion includes a reference pulse generation circuit that generates a reference pulse voltage serving as a reference for the pulse voltage, and a magnetic pulse compression circuit that carries out magnetic pulse compression on the reference pulse voltage.

9. The ozone generator according to claim 1, wherein:
the ozone generator is installed on a vehicle, and
the ozone generator generates an amount of ozone required to purify exhaust of the vehicle based on an operating status of the vehicle.
